(19) United States
(12) Patent Application Publication
(10) Pub. No.: US 2004/0252581 A1
(43) Pub. Date: Dec. 16, 2004

(54) Mixing device

(76) Inventor: Bie Dao Ting, Guangzhou (CN)

Correspondence Address: FLEIT KAIN GIBBONS GUTMAN & BONGINI, COURVOISIER CENTRE II, SUITE 404, 601 BRICKELL KEY DRIVE, MIAMI, FL, 33131, US

(21) Appl. No.: 10/684,833

(22) Filed: Oct. 14, 2003

(30) Foreign Application Priority Data
Jun. 16, 2003 (CN) 03247264.1

(51) Int. Cl. B01F 7/04

(52) U.S. Cl. 366/249; 366/252

(57) ABSTRACT

Mixing device having a container. A working part for insertion into the container and for sealing therewith. The working part includes a down gearing mounted thereon extending vertically downward in the working part terminating at a point spaced downward on the working part. A paddle defines a horizontal axis and is horizontally mounted on the working part for intruding into the container when the working part is fully inserted into the container whereupon it can rotate about its horizontal axis. The down gearing is coupled to the paddle to transmit power thereto, and one of a motor and a crank provides power to the down gearing.

### BACKGROUND OF THE INVENTION

1. Field of Invention

The present invention relates to a mixing device in the nature of a churn or frothing device to aerate a food, especially a liquid, while mixing.

2. Prior Art

Many devices are known for mixing foods, and many of them are used for churning or frothing. However most such devices are complicated in construction and consist of many parts. Assembly and cleaning of such devices is troublesome and time-consuming.

### SUMMARY OF THE INVENTION

The present invention seeks to overcome the disadvantages of prior art devices by providing a simpler mixing device that is constituted by only two components whose assembly and disassembly are readily effected with a minimum of effort. Cleaning of the novel mixing device of the present invention is accomplished easily. The advantages of the present invention will become more evident from the following detailed description when taken with the appended drawings.

### BRIEF DESCRIPTION OF THE DRAWINGS

FIG. 1 is an exploded perspective of the novel mixing device of the present invention.

FIG. 2 is a view in rear elevation partly broken away to illustrate an air pump.

FIG. 3 is a vertical sectional view taken along line A-A of FIG. 2.

FIG. 4 is a view in side elevation partly broken away to illustrate an alternative gearing arrangement.

FIG. 5 is a view like FIG. 4 illustrating a still further alternative gearing arrangement.

FIG. 6 is a vertical sectional view like FIG. 3 showing a manually driven mixing device according to the invention.

FIG. 7 is a view like FIG. 4 showing an alternative gearing arrangement for the manually driven mixing device of FIG. 6.

FIG. 8 is a view similar to FIG. 7 showing another alternative gearing arrangement.

FIG. 9 is a view similar to FIG. 7 showing a still further alternative gearing arrangement.

FIG. 10 is a partial view of the bottom of the container.

FIG. 11 is a view of FIG. 10 taken along line 11-11.

### DETAILED DESCRIPTION OF PREFERRED EMBODIMENTS OF THE INVENTION

Referring now to the drawings, the preferred embodiments of the mixing device constituting the present invention will be described in detail. The mixing device is a kind of machine or device to mix and blend sticky liquids of foods or food components to make, e.g. drinks, milk concoctions, fresh extracted and bottled juice, eggs, and so forth, and in particular to froth to form bubbles and creams. The main features are that the operation of the mixing device is very easy and it can make perfect bubbles and cream in a very short time.

The machine or device consists of two main parts, a transparent container 16 and a working part or component generally designated by the reference numeral 100, and connector of these two parts to hold them together in a locked or secure way.

The transparent container 16 has an elliptical shape in cross section and is a cylinder that is open at the top. The shape of container 16 features a protruding vertical U-shaped or convex slot 20 in the direction from up, starting at the top of the container to down to a point spaced from the bottom of the container. A trapazoidal rib 70 extends from the bottom of slot 20 to the bottom of the ocntainer to lend stability. This convex slot 20 is for inserting a sealed and sheltered extension gearing mechanism that constitutes part of the working part 100. A paddle 9 is rotatable mounted on the working part 100 to rotate within the container 16. Along the direction which the paddle 9 rotates, the shape of container, inner cross section, matches up with the shape or profile of the paddle 9, such arc to arc, and straight to straight.

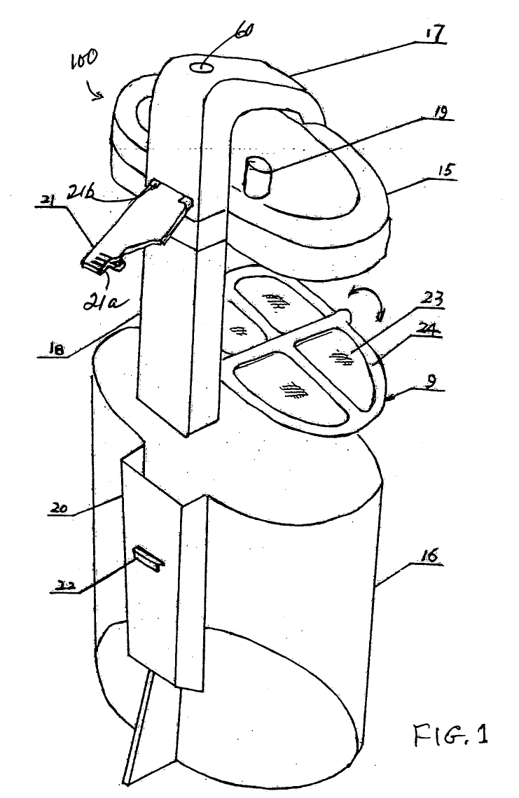

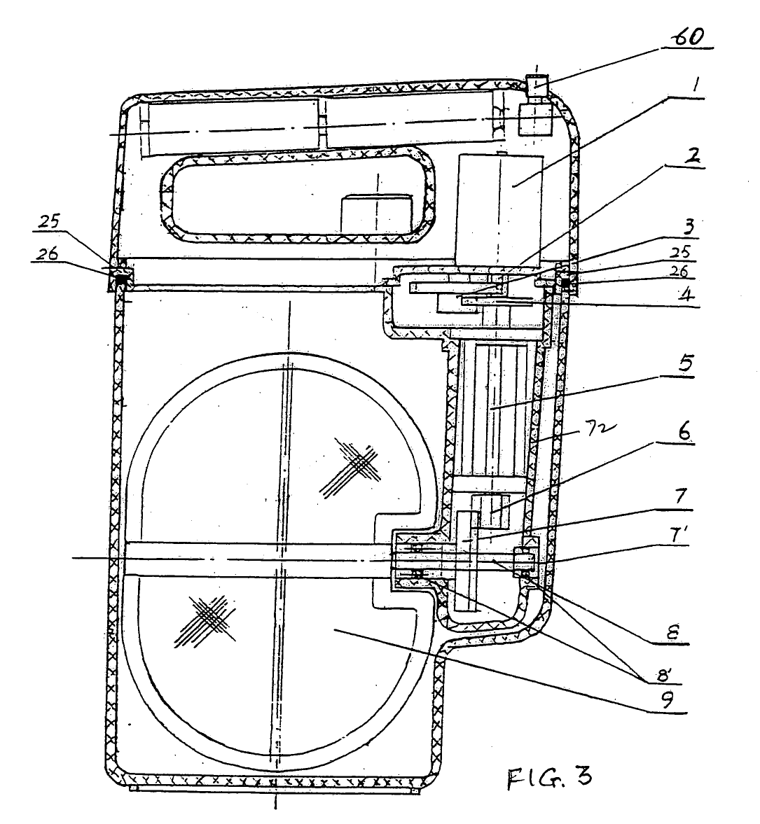

The working part 100 is an ensemble that is inserted into the container 16 as shown in FIG. 1 with a cover 15 that seats and seals on the top lip of the open top container 16 by means of a notch or channel 25 and a U-shaped air grommet washer 26, as seen in FIG. 3. Cover 15 and the extention-gearing part and paddle 9 go into the container 16. As noted, the working part consists in part of cover case 15, that is sealed to the top of container 16 and shelters and protects the down-gearing case 72, paddle 9. L-shaped lock bars 22 fixed to the U-shaped slot 20, front and back, coacts with lock plates 21 that have a latch 21a at its free end to coact with the lock bar 22 and lock the cover case 15 onto the container 16, under slight pressure. Plate 21 can be hinged, e.g. at 21b to handle 17 or can be flexible to enable it to be bent down so that end 21a can engage the lock bar 22.

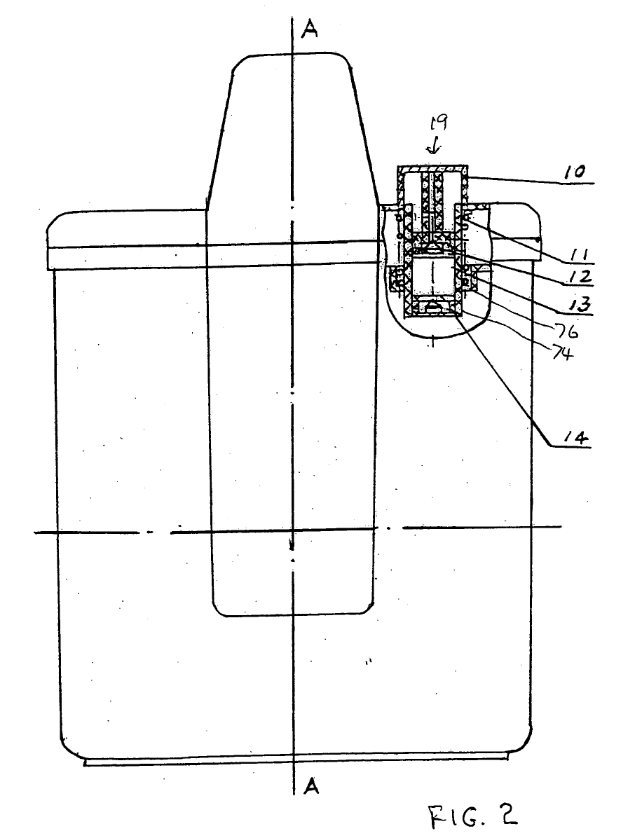

The cover case 15, which includes a hollow handle 17 houses a power driving mechnism or hand rotating mechnism inside of cover case as will be explained in more detail. An air pump is installed in the cover case 15, as can best be seen in FIG. 2, and consists of a housing 74 into which is mounted a plunger 10 that is spring biased upwardly by spring 11, the lower end of which is held in a cup 76 mounted on housing 74. A first air inlet valve 12 is mounted in housing 74, and spaced below in a second air inlet valve 14 with an air cylinder chamber 13 defined by the housing 74 inbetween the two air valves. The air pump enables air to be pumped into the container 16.

As noted, the cover case 15 is put on top of container 16 and locked, the cover 15 will seal the container 16.

An electric motor 1 is mounted on the cover case 15 in the larger hollow of the handle 17. A switch 60 is mounted on cover 15 to control the motor 1. The wires and power supply to the motor are conventional and omitted for sake of simplicity. Motor 1 has an output shaft projecting downward and contains a gear 2. An extension down gearing consisting of duplex gear 3, gear 4, shaft 5 and gear 6 carry the power down to the level of the paddle 9. Paddle 9 is mounted on a horizontal axis via shaft 8 which is bearing mounted in the down gearing case 72 in bearings 8′. The electric power lines to motor 1 are not shown for convenience.

The paddle 9 is made of a frame 24 holding a stainless mesh or grid 23. The frame can be plastic or stainless steel. The paddle, consisting of frame and stainless steel grid, is rotated around its horizon axis to beat and mix sticky liquid/cream and air in container 16 in as big area as posible to form froth when the container is sealed and air in container is not so easy to flow. The air grommet washer fixed into the slot on cover 15 can seal the container 16 when the cover is fitted on the container and locked on container. After the container is closed and sealed, the air in the container is not so easy to flow. The mesh or gridded paddle rotating along its horizontal axis mixes sticky liquid/cream and air to form bubbles.

The lock mechanism of the container and cover guarantee that the cover seals the container. All functional mechanisms which include power driving mechanism or hand rotating, air pump, sealed and sheltered extention gearing mechanism, and paddle are as a whole an ensemble, which can put onto and into (its sealed and sheltered extention gearing and paddle into) the container. The container will be closed and sealed, and the paddle 9 can be rotated properly to mix and blend the things in the container. Its purpose is for user to operate and clean it simply.

Also, the container protruding U-shaped or convex slot, seals and shelters the extension gearing mechanism to go down and procvide power to the paddle to rotate it along its horizon axis to mix and blend things in container as smoothly as possible.

As noted, on the cover case 15, there is an air pump. By stroking on the air pump, compressed air is introduced into the container 16 to enable stronger pressure. The air serves as an inertia to flow, so the paddle 9 can more easily mix sticky liquid or cream and air and to form bubbles.

Referring to FIG. 1 there is shown a lock plate 21 and a lock bar 22.

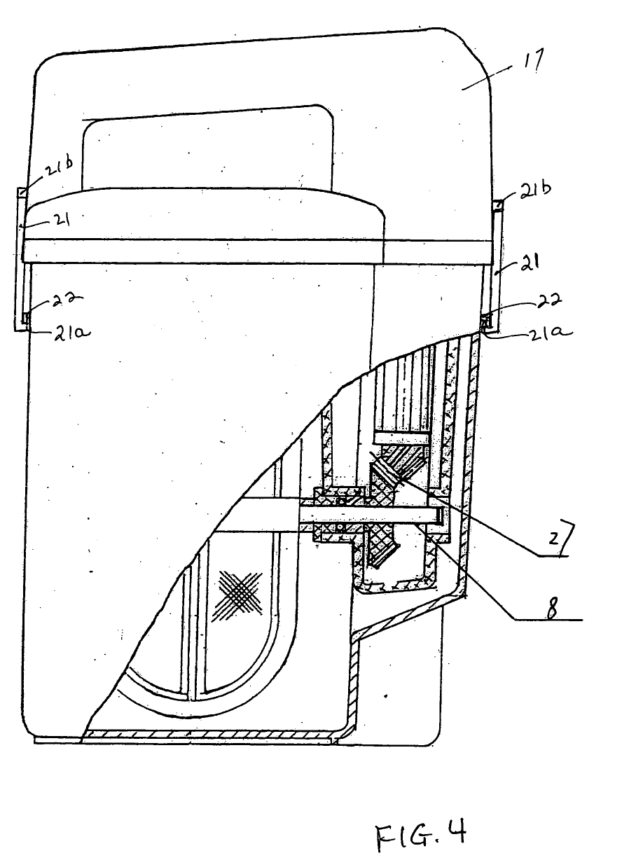

FIG. 4 shows an alternative gearing arrangement between the motor 1 and the paddle 9. As shown, the end of shaft 5 has mounted thereon an orthogonal gear 27 that meshes with a similar gear 27 on shaft 8. These gears are also referred to as bevel gears.

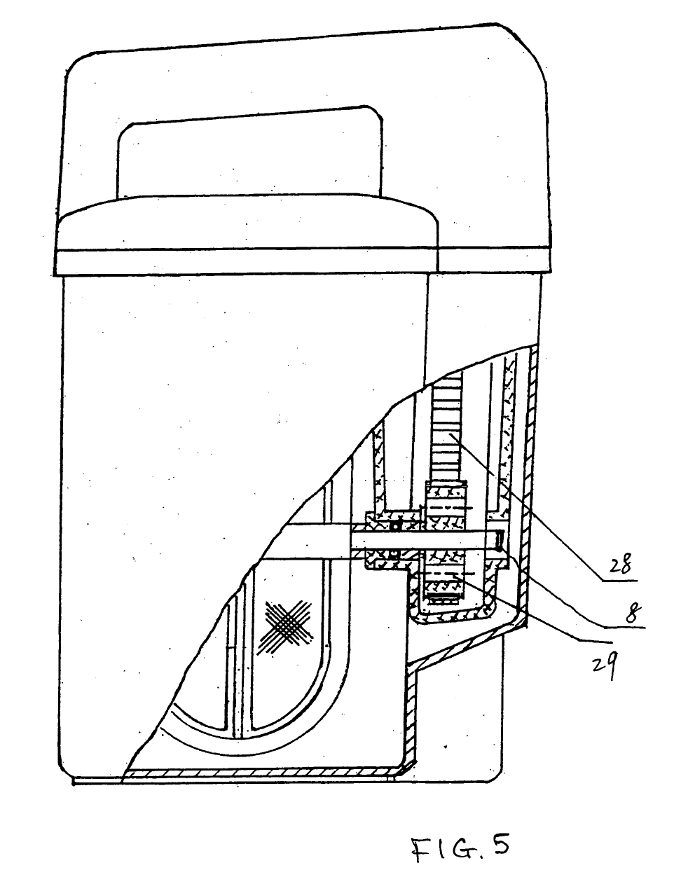

FIG. 5 shows a chain drive between the upper gear driven directly by motor 1 and a gear 29 on shaft 8, instead of shaft 5.

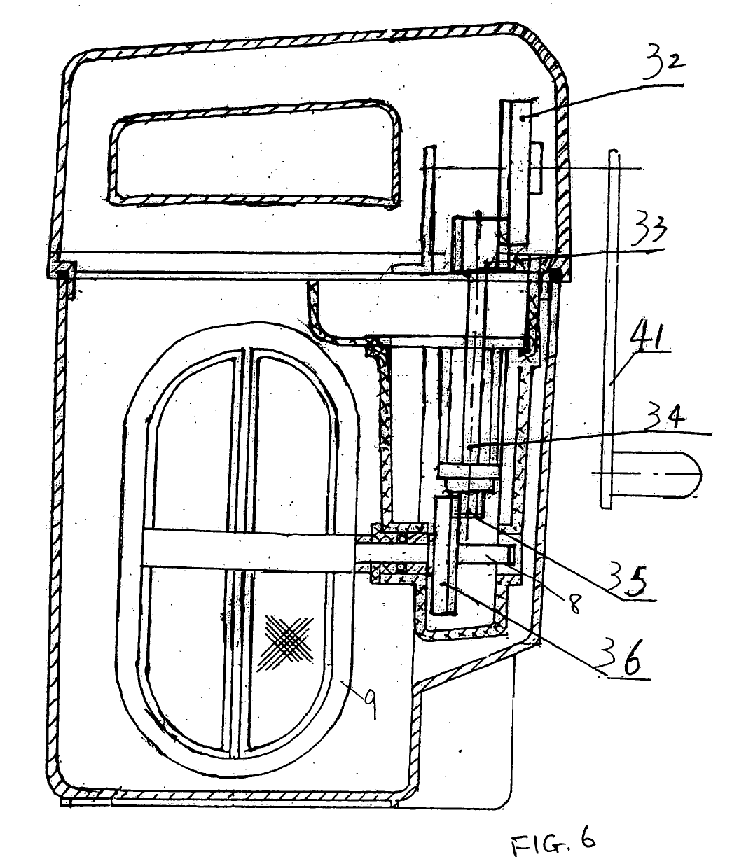

FIGS. 6 to 10 show a manually driven device. Instead of motor 1, the power is supplied by manually cranking the handle 41, which, in FIG. 6, rotates a shaft on which is journaled gear 32. A gear 33 meshes with gear 32 and inturn, drives shaft 34, that dirives gear 35 that drives gear 36 and shaft 8 of paddle 9.

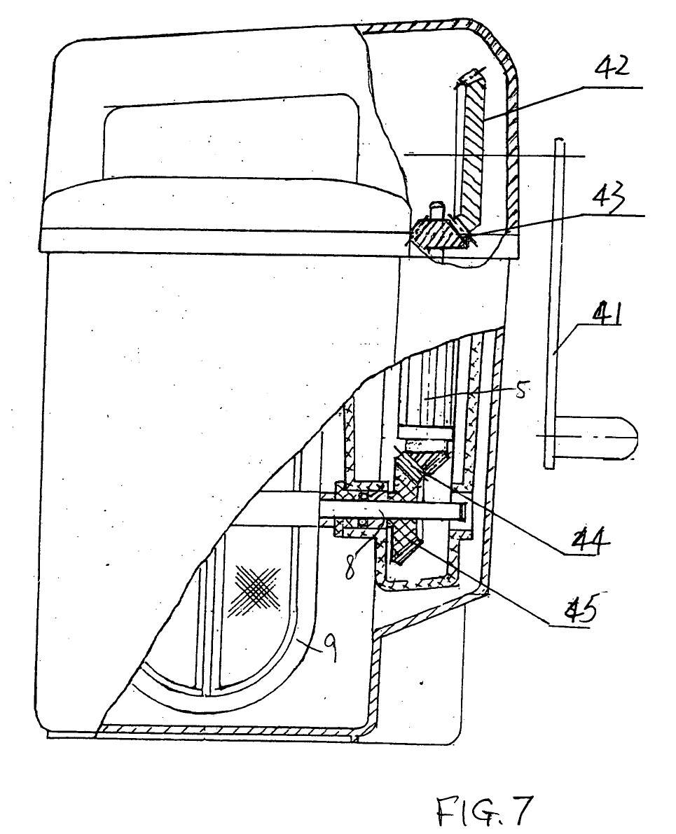

In FIG. 7, the handle 41 drives bevel gear 42, bevel gear 43, bevel gear 44 via shaft 5, and bevel gear 45 fixed on shaft 8.

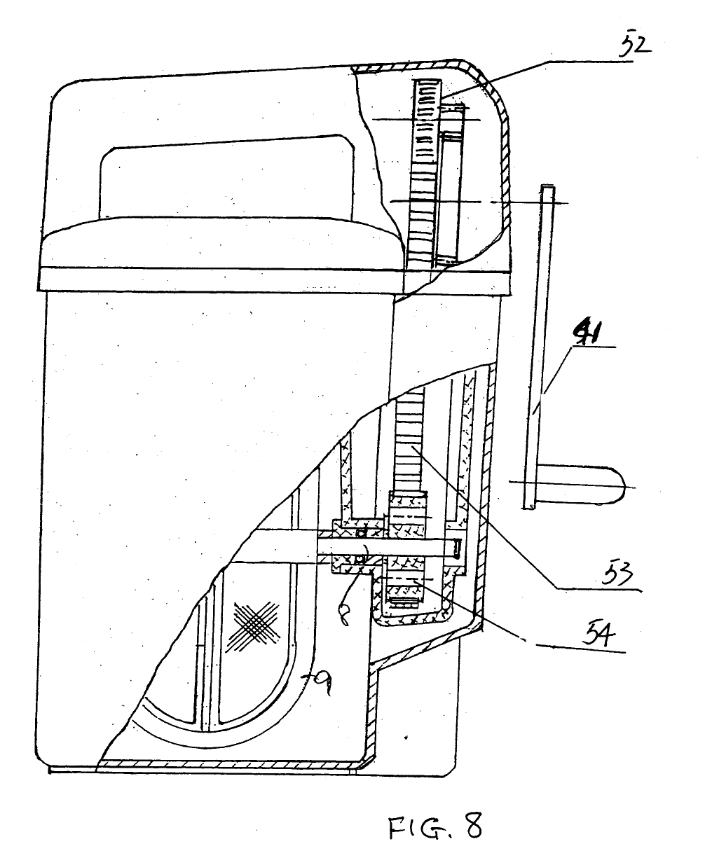

In FIG. 8, handle 41 drives a gear or wheel 52 that drive a synchronization belt or “O” type belt 53, that in turn, drives wheel or gear 54 fixed on shaft 8.

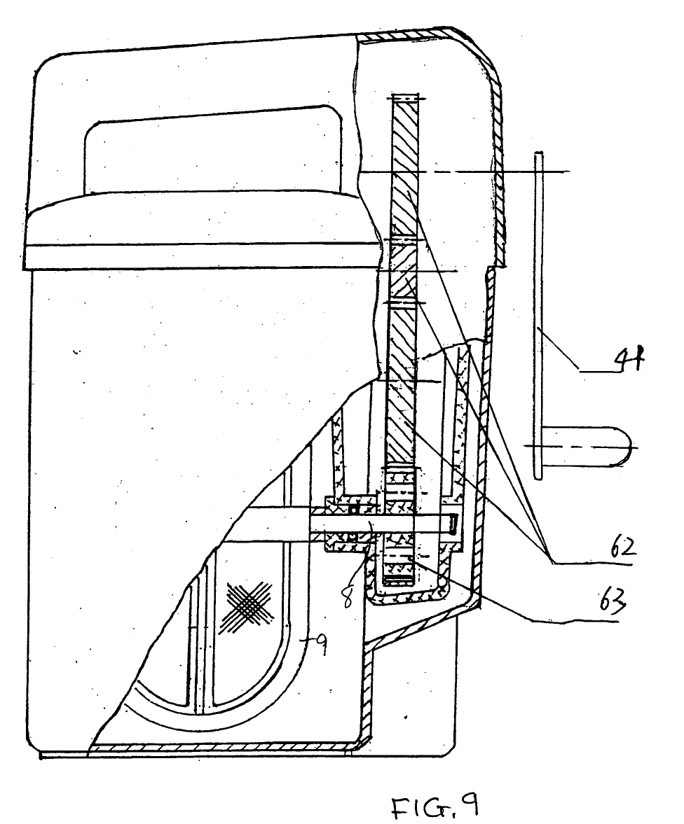

In FIG. 9, handle 41 drives a gear group 62 that meshes with and drives gear 63 fixed on shaft 8.

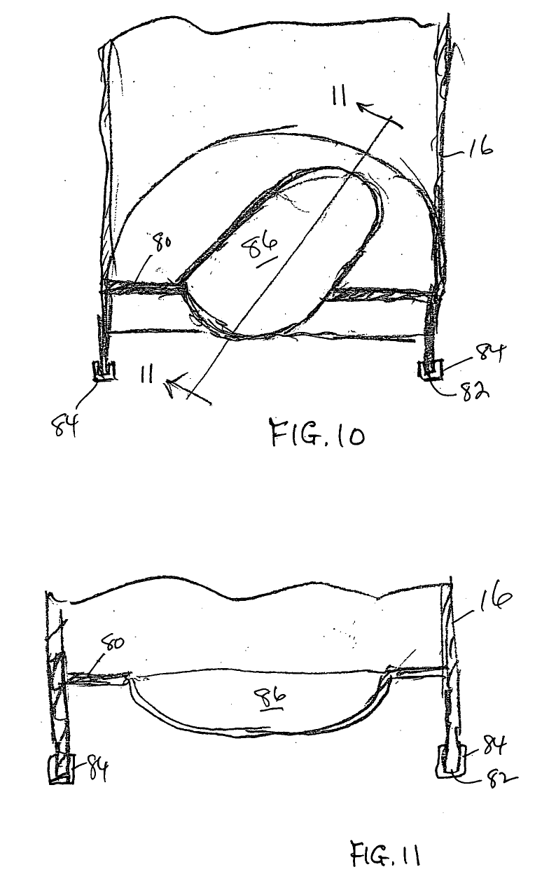

In FIG. 10 a partial view of the bottom of container 16 is shown illustrating a modification of the molded bottom structure. In this construction, the container 16 includes a floor 80 that is spaced iward from the bottom rim 82 of the container 16. A U-shaped rubber grommet washer 84 or the like is fitted over the rim 82 so that the container will not slip on whatever surface it is standing. The floor 80 is formed with a central recess 86 having a cross section that matches the profile of the end of the paddle 9 so that the paddle can sweep through the recess with a minimum of clearance. Stiffening ribs 88 serve to reinforce the floor 80 and bottom of container 16.

Although the present invention has been described in terms of specific embodiments, nevertherless changes and modifications will be evident to those of skill in the art that do not depart from the spirit scope and contemplation of the teachings herein. Such changes and modifications are deemed to fall within the purview of the applended claims.

What is claimed is:

1. Mixing device comprising a container and a working part for insertion into the container and for sealing therewith, said working part including a down gearing mounted thereon extending vertically downward in the working part terminating at a point spaced downward on the working part, and a paddle defining a horizontal axis and horizontally mounted on the working part for intruding into the container when the working part is fully inserted into the container whereupon it can rotate about its horizontal axis, said down gearing coupled to the paddle to transmit power thereto, and one of a motor and a crank to provide power to the down gearing.

2. Mixing device according to claim 1 wherein the working part includes a cover for the container.

3. Mixing device according to claim 2 wherein the cover includes a sealing element for sealing with the container.

4. Mixing device according to claim 1 wherein the paddle is mounted on a shaft that is driven by the down gearing.

5. Mixing device according to claim 1 wherein a lock is provided to seal the working part on the container.

6. Mixing device according to claim 1 wherein an air pump is mounted on the working part for pumping air into the container.

7. Mixing device according to claim 1 wherein the container includes a U-shaped channel for receiving the working part.

8. Mixing device according to claim 7 wherein the container defines a vertical cylindrical interior and the channel projects outwardly of the container to keep the interior of the container available for rotation of the paddle.

9. Mixing device according to claim 1 wherein the interior of the container enables rotation of the paddle about its horizontal axis.

10. Mixing device according to claim 1 wherein the working part includes a handle.
